(19) United States
(12) Patent Application Publication
(10) Pub. No.: US 2010/0250803 A1
(43) Pub. Date: Sep. 30, 2010

(54) Transmission System for a Computer System

(76) Inventor: Jia-Ching Lee, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/471,406

(22) Filed: May 24, 2009

(30) Foreign Application Priority Data
Mar. 24, 2009 (TW) 098109622

(51) Int. Cl. G06F 13/42; H04B 1/38

(52) U.S. Cl. 710/106; 455/73

(57) ABSTRACT

A transmission system for a computer system includes an active transmission interface, a host end and a device end. The host end includes a Bluetooth driving unit for generating a Bluetooth driving command, a first active connection unit for outputting the Bluetooth driving command or receiving a Bluetooth processing result via the active transmission interface, and an intermedium unit for emulating the first active connection unit as a Universal Asynchronous Receiver/Transmitter. The device end includes a Bluetooth module for performing baseband and radio processing, to generate the Bluetooth processing result, and a second active connection unit for outputting the Bluetooth processing result or receiving the Bluetooth driving command via the active transmission interface.

### BACKGROUND OF THE INVENTION

1. Field of the Invention

The present invention is related to a transmission system for a computer system, and more particularly, to a transmission system for a Bluetooth system of the computer system, for adopting a peripheral component interconnect (PCI) standard or a peripheral component interconnect express (PCI-E) standard between a host end and a device end of the Bluetooth system under the current standard, to reduce power consumption, and to combine other devices, so as to reduce production cost.

2. Description of the Prior Art

Bluetooth, a short-distance wireless communication technique, was initially developed by the cell phone manufacturer Ericsson for connecting a cell phone with portable devices. Since Bluetooth has advantages of low price, low power consumption and supporting audio transmission, applications thereof extend from the cell phone to computer systems, home multimedia devices, video game consoles, etc.

Please refer to FIG. 1, which is a schematic diagram of a Bluetooth system 10 of a computer system in the prior art. The Bluetooth system 10 can be generally divided into a host end 100 and a device end 102, which connect to each other via a transmission interface 104. The host end 100 can be regarded as a software part of the Bluetooth system 10. For the sake of conciseness, only a first connection unit 106 and a Bluetooth driving unit 108 are shown in FIG. 1. Also, the device end 102 can be regarded as a hardware part of the Bluetooth system 10, and thereby mainly consists of a second connection unit 110 and a Bluetooth module 112. In the Bluetooth system 10, the Bluetooth driving unit 108 is utilized for performing a Bluetooth driving program, and the first connection unit 106 is utilized for transmitting a related result or command via the transmission interface 104 to the second connection unit 110. Correspondingly, the second connection unit 110 is utilized for transmitting a processing result of the Bluetooth module 112 via the transmission interface 104 to the first connection unit 106 for computer system's further processing.

In order to broaden the utilization range of Bluetooth, related international organizations have established international standards and guidelines of Bluetooth as a basis for designers and manufacturers. For example, the transmission interface 104 has to conform to a host controller interface (HCI) standard, and thereby adopts specification of a universal asynchronous receiver/transmitter (UART) or a universal serial bus (USB). Note that, the UART specification is originally designed for cell phones, and the USB specification is developed for applications of computer systems, which is established by adding the USB protocol upon the UART protocol.

In the prior art, USB is a “passive” interface, i.e. the host end 100 has to regularly poll the device end 102 to ensure a steady connection. In such a situation, except data overhead, an increase of power consumption is induced, which is a disadvantage, especially for the portable computer systems.

### SUMMARY OF THE INVENTION

It is therefore a primary objective of the claimed invention to provide a transmission system for a computer system.

The present invention discloses a transmission system for a computer system. The transmission system comprises an active transmission interface, a host end and a device end. The host end comprises a Bluetooth driving unit, for performing a Bluetooth driving program and generating a corresponding Bluetooth driving command, a first active connection unit, coupled to the active transmission interface, for outputting the Bluetooth driving command or receiving a Bluetooth processing result via the active transmission interface, and an intermedium unit, coupled between the Bluetooth driving unit and the first active connection unit, for emulating the first active connection unit as a universal asynchronous receiver/transmitter (UART), to transmit the Bluetooth driving command to the first active connection unit. The device end comprises a Bluetooth module, for generating the Bluetooth processing result according to the Bluetooth driving command, and a second active connection unit, coupled between the active transmission interface and the Bluetooth module, for outputting the Bluetooth processing result or receiving the Bluetooth driving command via the active transmission interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a Bluetooth system of a computer system in the prior art.

FIG. 2 is a schematic diagram of a transmission system according to an embodiment of the present invention.

FIG. 3 is a schematic diagram of a combination of the transmission system of FIG. 2 and other devices.

### DETAILED DESCRIPTION

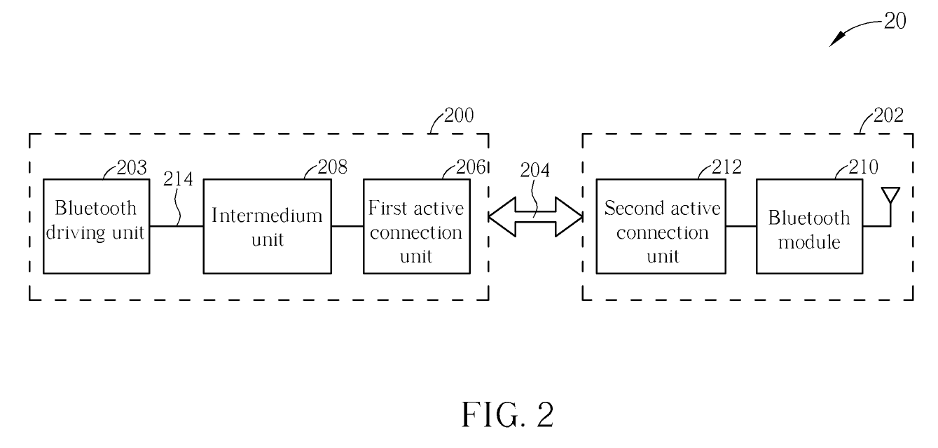

Please refer to FIG. 2, which is a schematic diagram of a transmission system 20 according to an embodiment of the present invention. The transmission system 20 is utilized for exchanging software and hardware signals of a Bluetooth system in a computer system. The transmission system 20 comprises a host end 200, a device end 202 and an active transmission interface 204. The host end 200 can be taken as a software part of the Bluetooth system, and comprises a Bluetooth driving unit 203, a first active connection unit 206 and an intermedium unit 208. The device end 202 can be taken as a hardware part of the Bluetooth system, and comprises a Bluetooth module 210 and a second active connection unit 212. In the host end 200, the Bluetooth driving unit 203 is utilized for performing a Bluetooth driving program and generating a corresponding Bluetooth driving command to the intermedium unit 208. The intermedium unit 208 is utilized for emulating the first active connection unit 206 as a universal asynchronous receiver/transmitter (UART), to transmit the Bluetooth driving command generated by the Bluetooth driving unit 203 to the first active connection unit 206. The first active connection unit 206 is utilized for outputting the Bluetooth driving command or receiving a Bluetooth processing result transmitted by the second active connection unit 212 via the active transmission interface 204. Correspondingly, in the device end 202, the Bluetooth module 210 can perform radio-frequency (RF) and baseband processing according to the Bluetooth driving command received by the second active connection unit 212, and generate the corresponding Bluetooth processing result to the second active connection unit 212, so as to feedback the Bluetooth processing result via the active transmission interface 204 to the first active connection unit 206.

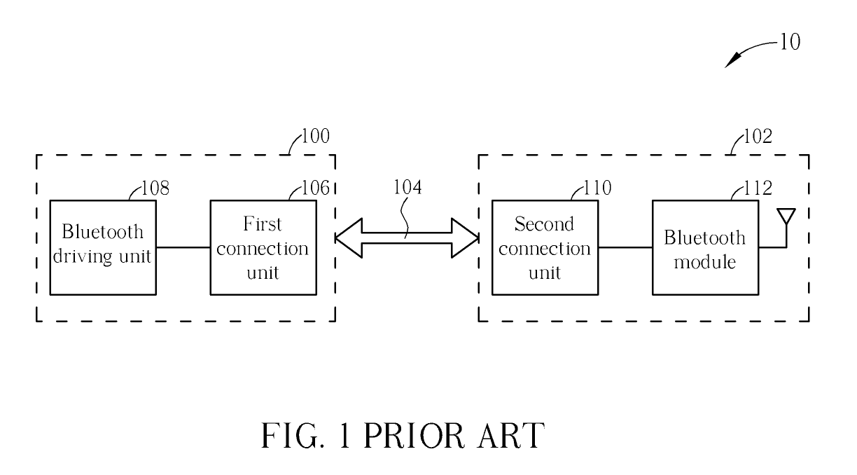

In short, the intermedium unit 208 can emulate the first active connection unit 206 as UART, such that the Bluetooth driving unit 203 can output the Bluetooth driving command in conformation with UART. In other words, the intermedium unit 208 achieves partial functions of the device end 102 shown in FIG. 1, such that in the transmission system 20, only a transmission interface 214 between the Bluetooth driving unit 203 and the intermedium unit 208 has to conform to the host controller interface (HCI) standard. As a result, under the current standard, the active transmission interface 204, the first active connection unit 206 and the second active connection unit 212 can adopt “active transmission standards”, such as peripheral component interconnect (PCI), peripheral component interconnect express (PCI-E), etc., to reduce power consumption. An “active transmission standard” means that a transmitter can directly output signals to a receiver without regularly polling the receiver.

Note that, since the intermedium unit 208 achieves partial functions of the device end 102 in FIG. 1, only the transmission interface 214 has to conform to HCI, such that the active transmission interface 204, the first active connection unit 206 and the second active connection unit 212 can adopt PCI or PCI-E, to reduce power consumption.

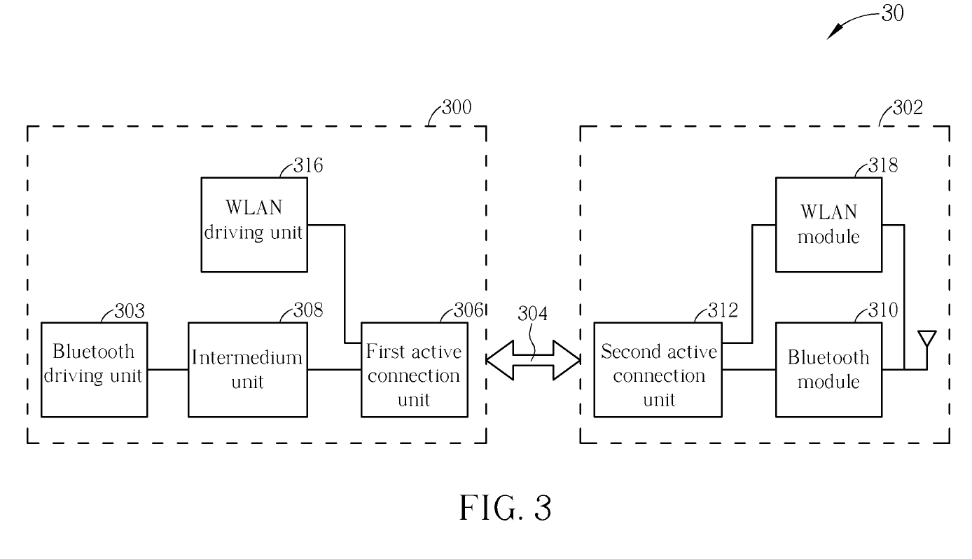

In addition, since PCI or PCI-E supports simultaneous connections of multiple devices, the present invention can further combine other devices, to reduce production cost. For example, please refer to FIG.3, which is a schematic diagram of a transmission system 30 according to an embodiment of the present invention. The transmission system 30 comprises a host end 300, a device end 302 and an active transmission interface 304. The host end 300 comprises a Bluetooth driving unit 303, a first active connection unit 306 and an intermedium unit 308. The device end 302 comprises a Bluetooth module 310 and a second active connection unit 312. Architecture and operations of the transmission system 30 are similar to those of the transmission system 20, except an additional wireless local area network (WLAN) driving unit 316 in the host end 300 and an additional WLAN module 318 in the device end 302. The WLAN driving unit 316 is coupled to the first active connection unit 306, and is utilized for performing a WLAN driving program and generating a corresponding WLAN driving command, to transmit the WLAN driving command via the first active connection unit 306 to the second active connection unit 312. The WLAN module 318 is coupled to the second active connection unit 312, and is utilized for generating a WLAN processing result according to the WLAN driving command generated by the WLAN driving unit 316. That is, in FIG. 3, the first active connection unit 306 and the second active connection unit 312 can further exchange the WLAN driving command and the WLAN processing result via the active transmission interface 304. In addition, since WLAN and Bluetooth operate in the same frequency band (about 2.4 GHz), the Bluetooth module 310 and the WLAN module 318 can share the same antenna, as illustrated in FIG. 3.

In the prior art, with respect to the Bluetooth system of the computer system, the transmission interface between the host end and the device end should conform to HCI standard, and USB is thereby adopted. Since USB is a “passive” interface, extra data overhead is required, and so is an increase of power consumption. In comparison, in the present invention, the host end of the Bluetooth system can achieve partial functions of the device end. Therefore, under the current standard, the Bluetooth driving unit can output the Bluetooth driving command in conformation with UART, and “active transmission standards”, such as PCI and PCI-E, can be adopted for transmitting signals between the host end and the device end, to reduce power consumption. Meanwhile, since PCI or PCI-E supports simultaneous connections of multiple devices, the present invention can further combine other devices, to reduce production cost.

To sum up, under the current standard, the present invention can adopt active transmission standards, such as PCI and PCI-E, etc., to reduce power consumption, and combine other devices to reduce production cost.

Those skilled in the art will readily observe that numerous modifications and alterations of the device and method may be made while retaining the teachings of the invention.

What is claimed is:

1. A transmission system for a computer system comprising:
an active transmission interface;
a host end comprising:
a Bluetooth driving unit, for performing a Bluetooth driving program and generating a corresponding Bluetooth driving command;
a first active connection unit, coupled to the active transmission interface, for outputting the Bluetooth driving command or receiving a Bluetooth processing result via the active transmission interface; and
an intermedium unit, coupled between the Bluetooth driving unit and the first active connection unit, for emulating the first active connection unit as a universal asynchronous receiver/transmitter (UART), to transmit the Bluetooth driving command to the first active connection unit; and
a device end comprising:
a Bluetooth module, for generating the Bluetooth processing result according to the Bluetooth driving command; and
a second active connection unit, coupled between the active transmission interface and the Bluetooth module, for outputting the Bluetooth processing result or receiving the Bluetooth driving command via the active transmission interface.

2. The transmission system of claim 1, wherein the first active connection unit, the active transmission interface and the second active connection unit conform to a peripheral component interconnect (PCI) standard.

3. The transmission system of claim 1, wherein the first active connection unit, the active transmission interface and the second active connection unit conform to a peripheral component interconnect express (PCI-E) standard.

4. The transmission system of claim 1, wherein the host end further comprises a wireless local area network (WLAN) driving unit, coupled to the first active connection unit, for performing a WLAN driving program and generating a corresponding WLAN driving command.

5. The transmission system of claim 4, wherein the device end further comprises a WLAN module, coupled to the second active connection unit, for generating a WLAN processing result according to the WLAN driving command.

6. The transmission system of claim 5, wherein the first active connection unit is further utilized for outputting the WLAN driving command or receiving the WLAN processing result via the active transmission interface, and the second active connection unit is further utilized for outputting the WLAN processing result or receiving the WLAN driving command via the active transmission interface.

7. The transmission system of claim 5, wherein the WLAN module and the Bluetooth module share an antenna.

8. A transceiver comprising:
a Bluetooth module, for generating a Bluetooth processing result according to a Bluetooth driving command;
a wireless local area network (WLAN) module, for generating a WLAN processing result according to a WLAN driving command; and
an active connection unit, coupled to an active transmission interface, the Bluetooth module and the WLAN module, for outputting the Bluetooth processing result and the WLAN processing result or receiving the Bluetooth driving command and the WLAN driving command via the active transmission interface.

9. The transceiver of claim 8, wherein the Bluetooth driving command and the WLAN driving command are transmitted by a host end via the active connection unit to the active transmission interface.

10. The transceiver of claim 8, wherein the active transmission interface and the second active connection unit conform to a peripheral component interconnect (PCI) standard.

11. The transceiver of claim 8, wherein the active transmission interface and the second active connection unit conform to a peripheral component interconnect express (PCI-E) standard.

12. The transceiver of claim 8, wherein the WLAN module and the Bluetooth module share an antenna.
